(19) United States
(12) Patent Application Publication
(10) Pub. No.: US 2005/0173597 A1
(43) Pub. Date: Aug. 11, 2005

(54) Pipe and cable support apparatus and method

(75) Inventors: Michael Geren Farrell, Columbia, SC (US); Mark Eugene Moore, Columbia, SC (US); Vance Martin Patterson, Morganton, NC (US); Donald Jay Thomas JR., Evergreen, CO (US); Henry Lee Yonce, Winter Haven, FL (US)

Correspondence Address: SUGHRUE MION, PLLC, 2100 PENNSYLVANIA AVENUE, N.W., SUITE 800, WASHINGTON, DC, 20037, US

(73) Assignee: PATTERSON VENTILATION CO., INC.

(21) Appl. No.: 10/775,119

(22) Filed: Feb. 11, 2004

(51) Int. Cl. F16L 3/22

(52) U.S. Cl. 248/68.1

(57) ABSTRACT

The present invention relates to a support block and a system for roof cooling. The support block supports a pipe above a structure, wherein the pipe has a cross sectional area and a diameter of predetermined dimensions, and the support block includes a number of outer surfaces each having an opening and a cavity. Each cavity has a cross sectional area larger than the cross sectional area of a pipe and the opening can be less than the diameter of the cavity cross sectional area or slightly less than the diameter of a pipe. Dovetail notches on the surfaces of the support block are present to attach the support block onto the roof. Adhesives can be used in the dovetail notches or an adaptor plate attached to the roof can be used to attach the support block to the adaptor plate. Alternatively, the support block can be used to assist in supporting and routing any type of conduit or cabling.

### BACKGROUND OF THE INVENTION

1. Field of the Invention

This invention relates to a support apparatus and a support method. More particularly, the invention relates to a support block for supporting pipes and cables above or below a surface including roofs and ceilings and a method for the same. Further, the invention relates to a system for cooling roofs using conduit support blocks.

2. Description of the Related Art

In commercial and residential buildings, there are numerous pipes, conduits, cables, wires, and the like, of various sizes installed on or inside the buildings. Often, there is a hodgepodge of pipes, conduits, cables, and wires run above or below ceilings, on or below roofs, or along or next to a structural or aesthetic member of the building. To support or arrange these pipes, conduits, cables, and wires, certain means or devices are used which can have high unit cost, and require the use of installation tools or a large amount of man-hours to install, especially for large-scale projects.

For example, in the roof cooling industry, buildings are cooled by the application of water spray to the roof of the buildings. The water spray is applied on the roof surface by spray heads distributed on plastic piping. To install the pipes on the roof, the pipes are strapped on a supporting block using copper straps and nails, and the blocks are placed on the roof surface.

The pipes, however, are exposed to the environment, including the ambient temperature and solar radiation, and therefore undergo thermal expansion and contraction. If the pipes are fixed onto the supporting structures and the supporting structures are themselves fixed onto the roof, the expansion and contraction of the pipes can impart stress and potentially damage the supporting structures or the roof surface or both.

To prevent the expansion and the contraction of pipes from causing damage, pipes may be loosely strapped onto support blocks which are fixed onto the roof. Alternatively, the pipes are fixedly clamped to the top of a stem-like support structure with a pan-shaped base. When the pipes expand or contract, the stem and the base move with the pipes and the rounded edges of the pan permit the base to slide on the roof.

For a roof cooling system with a number of pipe runs and requiring a large number of supporting structures, the total amount of time and labor required to install the individual supporting structures in a roof cooling system, for example, becomes prohibitively expensive. Similarly, the installation of pipes, conduits, cables, or wires could also incur high cost. Therefore, means for installing pipes, conduits, cables, wires, or even a roof cooling system that has low product and implementation cost is desired.

### SUMMARY OF THE INVENTION

The present invention is directed to a support apparatus for supporting a pipe or a cable from a structure, wherein the pipe or the cable has a cross sectional area and a diameter of predetermined dimensions, the support apparatus comprising a plurality of outer surfaces wherein each outer surface comprises at least one corresponding opening and at least one corresponding cavity. Each cavity has a cross sectional shape larger than the shape of the pipe or the cable of a predetermined shape, and an opening having a width less than the diameter of the cavity cross sectional area or less than the nominal diameter of the pipe or the cable.

The support apparatus includes means for coupling the support apparatus to a surface of a structure, such as a roof. In one embodiment, the plurality of outer surfaces may include dovetail notches to join the pipe support apparatus to a surface of a structure, such as a roof. In another embodiment, an adhesive is applied in the dovetail notches. In yet another embodiment, the dovetail notches couple to an adaptor plate fixed to the roof.

In one embodiment, a roof cooling system for providing a cooling effect on a roof, the system comprising a plurality of pipes, a plurality of spray heads arranged on each pipe for spraying water on the roof, a controller for controlling the spraying of water, and a plurality of support blocks for supporting the plurality of pipes above the roof, wherein each block comprises a plurality of outer surfaces, each outer surface having at least one opening communicating with a cavity, each cavity being designed to fit a pipe of a predetermined diameter, is disclosed.

In yet another embodiment, there is a support apparatus for supporting at least one of a pipe of predetermined dimensions and/or a cable or the like, the apparatus having an axial direction parallel to an axial direction of the pipe or the cable, and a radial direction radially perpendicular to the axial direction, the apparatus comprising a plurality of projecting arms extending substantially in the radial direction, wherein two adjacent projecting arms cooperate to support one of a pipe and a cable thereinbetween.

### BRIEF DESCRIPTION OF THE DRAWINGS

Other features and advantages of the present invention will be apparent from the following description taken in connection with the accompanying drawings, wherein:

FIG. 1 is a perspective view of an embodiment of the invention;

FIG. 2A is a cross sectional view of an embodiment of the invention;

FIG. 2B is a perspective view of a roof cooling system;

FIG. 3 is a bottom perspective view of another embodiment of the invention showing dovetail notches;

FIG. 4 is a cross sectional view of the embodiment shown in FIG. 3 with adhesive applied;

FIG. 5 is a perspective view of an adaptor plate;

FIG. 6 is a cross sectional view of the embodiment shown in FIG. 3 coupled to the adaptor plate shown in FIG. 5;

FIG. 7 is a cross sectional partial view of another embodiment of the invention showing a coupler joining two blocks;

FIG. 8 is a cross sectional partial view of a beveled surface of an embodiment;

FIG. 9 is a perspective view of an embodiment of the invention incorporating dovetail notches and beveled surfaces;

FIG. 10 is a cross sectional view of another embodiment of the invention for accommodating a plurality of pipes or cables at one surface of a block; and

FIG. 11 is yet another embodiment of the invention in a perspective view.

### DETAILED DESCRIPTION OF THE EXEMPLARY EMBODIMENTS

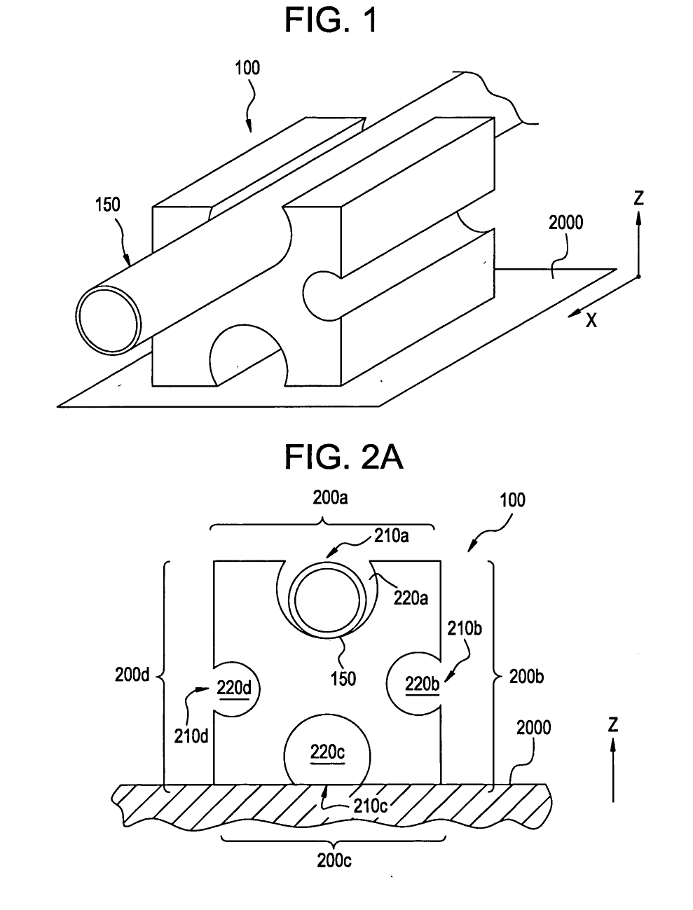

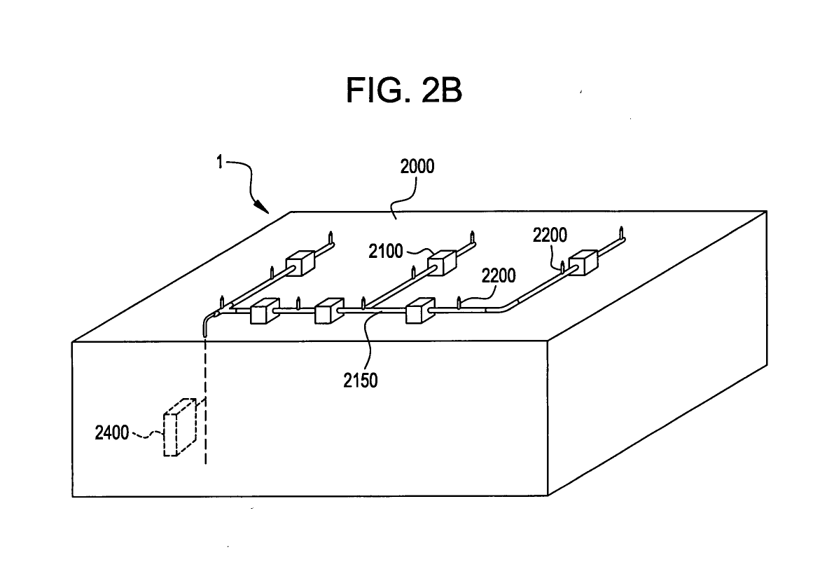

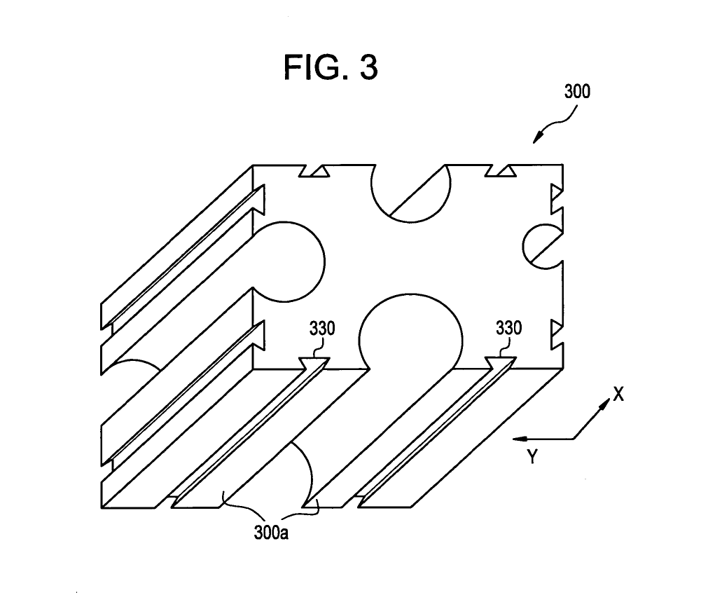

An exemplary embodiment will now be described with reference to FIGS. 1, 2A, and 2B. A perspective view of a support block 100 is shown in FIG. 1, and a cross sectional view of the same is shown in FIG. 2A. The support block 100 rests on the surface of a structure such as a roof, ceiling tiles, structural frame, or the like. Alternatively, in another embodiment, the support block is disposed or suspended below such structures. The support block 100 can support at least one of pipes, conduits, cables, wires, and the like. In FIG. 2A, the support block rests on the surface of a roof 2000 and a pipe 150 fitted in the support block 100. The following embodiment describes the support block 100 as used in an exemplary application.

As shown in FIG. 2B, the pipe 150 is one of a plurality of pipes 2150 of a roof deck cooling system 1. The roof deck cooling system 1 utilizes water distributed to and applied on the surface of the roof 2000 through spray nozzles 2200. The spray nozzles 2200 and the distribution of water is controlled by an electronic controller 2400. The evaporation of the water cools the roof 2000 heated by environmental conditions such as solar radiation and internal conditions of the building, e.g., heat generated by machinery. As a result, the roof radiates less infrared energy into the workplace of the building below so that the building will trap and retain less heat.

The pipes 2150 are supported by a plurality of support blocks 2100 arrayed on the surface of the roof 2000. In FIG. 2A, there is a cross sectional view of a support block 100 with four surfaces 200a, 200b, 200c, and 200d. In the center of each of the surfaces 200a, 200b, 200c, and 200d there is an opening 210a, 210b, 210c, and 210d, respectively. Each of the openings 210a, 210b, 210c, and 210d communicate with a cavity 220a, 220b, 220c, and 220d, respectively. The cavities 220a, 220b, 220c, and 220d all extend through the entire length of the support block 100 in the axial direction X and have a circular cross sectional area. Alternatively, in another embodiment shown in a figure to be described below, the cavities have an oval cross sectional area.

Each of the openings 210a, 210b, 210c, and 210d and its corresponding cavities 220a, 220b, 220c, and 220d have dimensions to accommodate a pipe or a cable of a particular diameter. For example, cavity 220a has a diameter of 2.840 inches and an opening 210a of 2.234 inches so the cavity 220a and opening 210a can be fitted with a pipe having an outer diameter of, for example, around 2 inches and preferably 2.25 inches. Additionally, cavity 220b has a diameter of 1.740 inches and an opening 200B of 1.242 inches to accommodate a pipe having an outside diameter of, for example, around 1 inch and preferably 1.25 inches. The openings may be preferably slightly smaller than the nominal diameter of the pipe to permit a “snap-in” fit, whereby at least one of the pipe and the opening is made of pliable materials.

In use, the support block 100 is placed on a roof 2000 where a pipe 150 of known dimensions is to be run. The support block 100 is placed so that a cavity which can fit the diameter of the pipe 150, i.e., cavity 220a, faces upward in the vertical direction Z, as shown in FIG. 2A. As the pipe 150 is laid on the roof 2000, the pipe 150 is simply fit in the cavity 220a.

Because the dimensions of the cavity 220a are larger than the dimensions of the pipe 150, the pipe 150 can easily slide within in the cavity 220a along the axial direction X as the pipe 150 undergoes thermal expansion or contraction.

To manufacture a support block such as the support block 200 above, any suitable material may be used. In one embodiment, extrudable polymers such as polyvinylchloride, and the like can be used. In outdoor roof cooling systems, polymers resistant to the deteriorating effects of ultraviolet light are desirable, in an exemplary embodiment. The support block can be extruded or formed from a mold to achieve the desired shape.

FIG. 3 shows another embodiment of the invention depicting parallel dovetail notches on each of the surfaces of a support block 300. FIG. 3 shows a bottom perspective view of a support block 300 having a pair of parallel dovetail notches 330 disposed on the surface 300a along an axial direction X. Likewise, there are dovetail notches disposed on the remaining surfaces of the support block 300. It is noted that the orientation of the dovetail notches 330 is not limited to the axial direction X, but can be oriented in other directions such as the lateral direction Y. The support block 300 shown in FIG. 3 is similar to the support block 100 shown in FIGS. 1 and 2 and the common parts shared between the support block 100 and the support block 300 will not be described hereinafter.

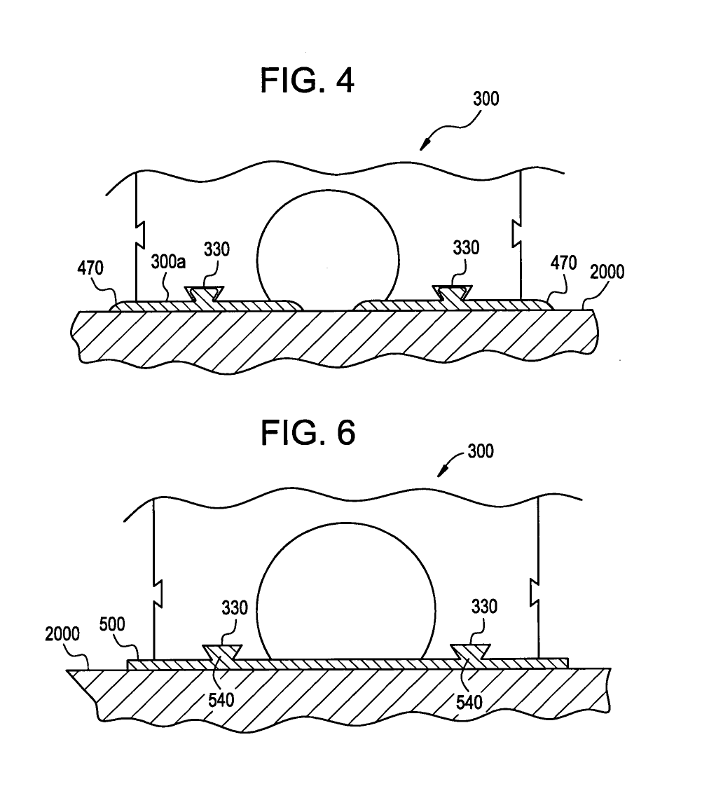

The dovetail notches 330 serve to join the support block 300 to the surface of a structure such as a roof 2000, as shown in FIGS. 4 and 6. It is noted that the means for joining the support block 300 to a structure is not limited to a notch with a dovetail cross section but can assume other suitable cross sectional shapes, including saddle shapes.

In FIG. 4, an adhesive 470 is used to join the support block 300 to the roof 2000. It is desirable to choose an adhesive 470 which provides a favorable bonding property with the roof surface and the material used in making the support block. To join the support block 300 to the roof 2000, a generous amount of adhesive 470 is applied to the dovetail notches 330. The adhesive 470 can also be applied to the areas of the surface 300a around the dovetail notches 330. The support block 300 is pressed down on the roof 2000 so the adhesive 470 fills the dovetail notch 330 and a layer of adhesive 470 is formed between the surface 300a and roof 2000. As the adhesive 470 cures, the chemical bonding property of the adhesive 470 bonds the surface 300a to the roof 2000.

The chemical bond, however, may be weak or become weak over time due to the leaching of chemicals from the material from which surface 300a or roof 2000 is made, the inert chemical property of the material vis-à-vis the adhesive 470, or the degradative effects of environmental exposure. In this case, the physical shape of the cured adhesive 470 in the dovetail notches 330 mechanically joins the support block 300 to the roof 2000. In other words, the flared shape of the cured, i.e., solidified, adhesive 470 in the tapered dovetail notches 330 restricts the movement of the support block 300.

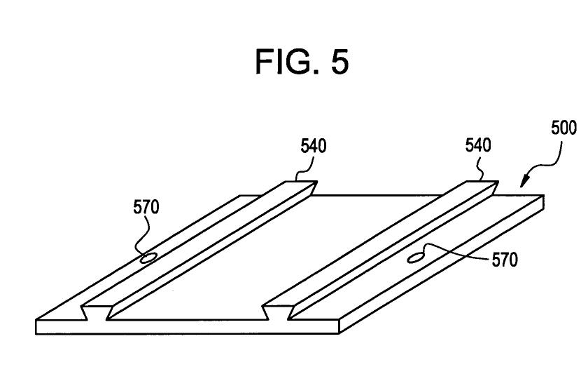

FIGS. 5 and 6 show another embodiment of the invention showing an adaptor plate 500 for joining the support block 300 to the roof 2000. On the adaptor plate 500, there is a pair of parallel dovetail plugs 540 which fit into the dovetail notches 330 of the support block 300. In the adaptor plate 500, there are holes 570 to mount the adaptor plate 500 to the roof 2000.

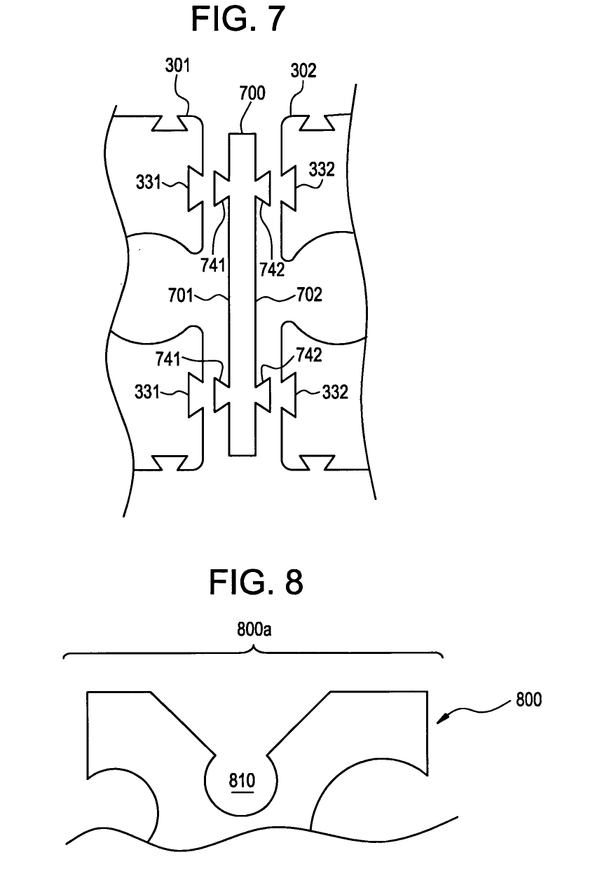

In another embodiment shown in FIG. 7, there is a cutaway drawing of a first support block 301 and another cutaway drawing of a second support block 302. There is a coupler 700 disposed between the first support block 301 and the second support block 301 to join the same. The coupler 700 has two surfaces, a first lateral surface 701 and a second lateral surface 702, which are on opposite sides of the coupler 700. On the first lateral surface 701 of the coupler 700, there is a pair of dovetail plugs 741 and on the second lateral surface 702 of the coupler 700, there is another pair of dovetail plugs 742. To join the first and second support blocks 301 and 302 together, the dovetail plugs 741 and 742 fit in the dovetail notches 331 and 332, respectively. In another configuration, instead of the coupler 700, there are means for snapping the first and second support blocks 301 and 302 together, means for snapping including snap fasteners, in another embodiment. Additionally, in lieu of the coupler 700, other means for coupling known in the art can be used.

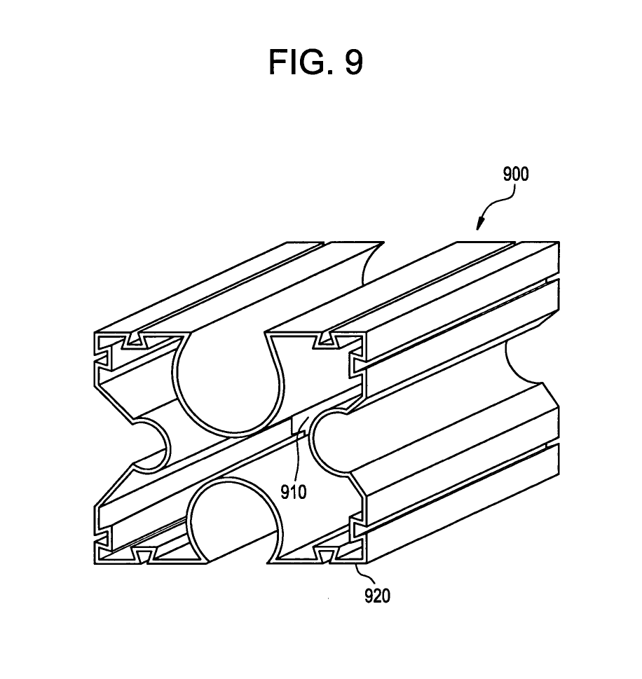

In an alternative embodiment shown in FIG. 8, a support block 800 has an inwardly beveled surface 800a angled toward a cavity 810. When a pipe is placed on the beveled surface 800a, the slope of the beveled surface 800a cams the pipe toward the cavity 810. Consequently, the beveled surface 800a permits the pipe to be fit into the cavity 520a without requiring a precise alignment of the pipe directly over the cavity 520a.

In FIG. 9, an embodiment of the invention incorporating the support block 900 is shown to have a thin outer surface 920 and a center plate 910 disposed in a hollow interior of the support block 900.

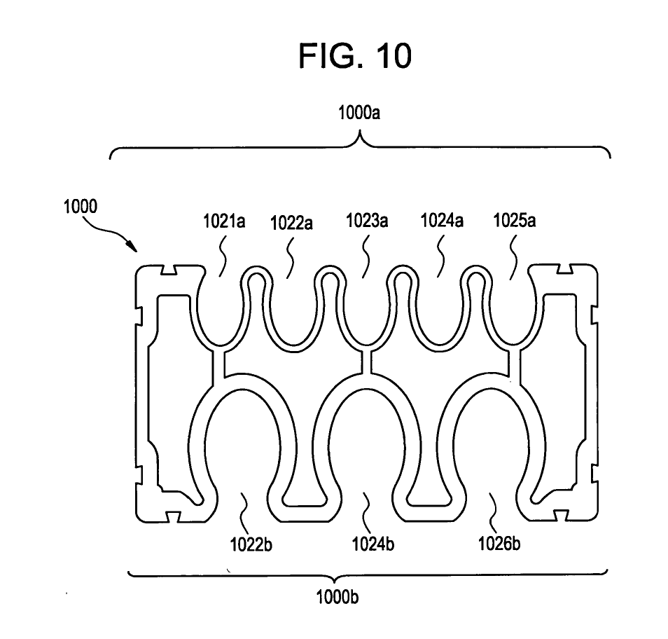

In FIG. 10, a cross sectional view of another embodiment of the invention showing a multi-support block 1000. In contrast to the above embodiments, there are five cavities 1021a, 1022a, 1023a, 1024a, and 1025a, at a surface 1000a of support block 1000. At an opposite surface of the multi-support block 1000, surface 1000b has three cavities 1022b, 1024b, and 1026b. In this embodiment, a number of pipes or cables arranged in close proximity to each other can be supported by using one multi-support block 1000.

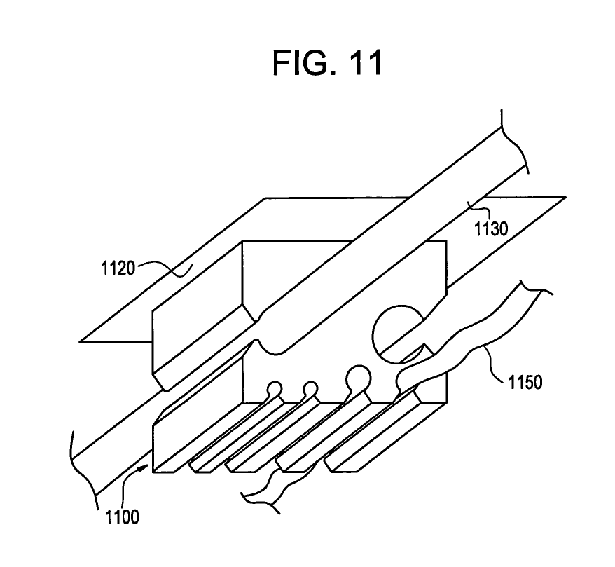

In an alternative embodiment shown in FIG. 11, there is a support block 1100. The supporting block 1100 supports a cable 1150 and in this exemplary embodiment, the support block 1100 is installed below or suspended from a ceiling 1120. Alternatively, the support block 1100 is installed at a bottom of an overhanging structural member. In another configuration, the support block 1100 is suspended by the pipe 1130 fit into a cavity of the support block 1100.

In yet another alternative embodiment, the support block 110 is installed or laid above ceiling tiles.

It is contemplated that numerous modifications may be made to the present invention without departing from the spirit and scope of the invention as defined in the following claims. For example, the invention can be used for any type of common conduit or electrical or communications cabling, in order to assist in routing the cabling from point to point, or as an alternative to bundling the cabling.

1. A support apparatus for supporting at least one of a pipe and a cable spaced from a structure, the at least one of the pipe and the cable having a cross sectional area and a diameter of predetermined dimensions, the support apparatus comprising:
a plurality of outer surfaces;
an opening disposed at at least one outer surface; and
an inner cavity being disposed inward from the opening and having a cross sectional area larger than the nominal cross sectional area of the at least one of the pipe and the cable.

2. The support apparatus as claimed in claim 1, wherein each of the plurality of outer surfaces includes a corresponding opening and a corresponding inner cavity.

3. The support apparatus as claimed in claim 2, wherein the corresponding inner cavities for the plurality of outer surfaces have different sizes.

4. The support apparatus as claimed in claim 1 further comprising a plurality of openings in at least one of said outer surfaces.

5. The support apparatus as claimed in claim 1 further comprising coupling means for coupling the support apparatus to a surface of the structure.

6. The support apparatus as claimed in claim 5, wherein the coupling means comprises at least one notch disposed in at least one of said plurality of outer surfaces.

7. The support apparatus as claimed in claim 6, wherein the coupling means further comprises an adhesive applied in said notch of the outer surface facing said structure.

8. The support apparatus as claimed in claim 6, wherein the outer surface facing the surface of the structure connects to an adaptor plate comprising a base plate and at least one plug, each plug fitting inside one said notch.

9. The support apparatus as claimed in claim 1, further including a means for coupling the support apparatus to another support apparatus.

10. The support apparatus as claimed in claim 9, wherein the means for coupling includes a notch and a plug, wherein the notch of one support apparatus couples with the plug of the another support apparatus.

11. The support apparatus as claimed in claim 1, further including a means for snapping the support apparatus and another support apparatus together.

12. The support apparatus as claimed in claim 1, wherein the opening has a width less than the nominal diameter of the at least one of pipe and cable and the cavity cross sectional area.

13. The support apparatus as claimed in claim 12, wherein the outer surface slopes inwardly toward the opening to cam the at least one of pipe and cable toward the cavity when the at least one of pipe and cable is pushed inwardly of the outer surface.

14. The support apparatus as claimed in claim 12 further comprising coupling means for coupling the support apparatus to the structure.

15. The support apparatus as claimed in claim 14, wherein the coupling means couples the support apparatus below the structure.

16. A roof cooling system for providing a cooling affect on a roof, the system comprising:
a plurality of pipes;
a plurality of spray heads arranged on each pipe of the plurality of pipes for spraying water on the roof;
a controller for controlling the spraying of water; and
a plurality of support blocks for supporting the plurality of pipes above the roof, wherein each block comprises a plurality of outer surfaces, each outer surface having at least one opening communicating with a cavity, each cavity being designed to fit a pipe of a predetermined diameter.

17. The roof cooling system as claimed in claim 16, wherein each support block further comprises means for joining the support block to a surface of the roof.

18. The roof cooling system as claimed in claim 17, wherein the means for joining comprises at least one notch on a bottom surface of the support block.

19. The roof cooling system as claimed in claim 18, wherein the means for joining further comprises an adhesive applied in the notch.

20. The roof cooling system as claimed in claim 18 further comprising an adaptor plate comprising at least one plug, wherein the adaptor plate is joined to the surface of the roof, and the plug couples to the notch.

21. A support apparatus for supporting at least one of a pipe and a cable, the apparatus having an axial direction substantially parallel to an axial direction of the at least one of the pipe and the cable, and a radial direction substantially radially perpendicular to the axial direction, the apparatus comprising:
a plurality of projecting arms extending substantially in the radial direction, wherein two adjacent projecting arms cooperatively support the at least one of the pipe and the cable thereinbetween.

22. The support apparatus as claimed in claim 21, wherein the adjacent projecting arms cooperatively form a cavity having a diameter greater than the nominal diameter of said at least one of the pipe and the cable, distal ends of the projecting arms cooperatively forming an opening of the cavity.

23. The support apparatus as claimed in claim 21, further comprising means for joining the apparatus to a structure, wherein the means for joining is disposed at at least one distal end of the plurality of projecting arms.

24. The support apparatus as claimed in claim 23, wherein the means for joining comprises a notch.

25. The support apparatus as claimed in claim 24, wherein the means for joining further comprises an adhesive disposed in the notch.

26. A cable supporting apparatus, comprising:
a block member defining plural surfaces, at least one of said plural surfaces including a plurality of openings leading to cavities into which a cable may be received, said openings having a width smaller than a nominal diameter of said cable.

27. The cable supporting apparatus as claimed in claim 26, wherein said openings and corresponding cavities are of varying sizes in order to accommodate cables of correspondingly size.

28. The cable supporting apparatus as claimed in claim 26, wherein said block is formed of an extrudable plastic, and said cavities are all parallel to an axial direction of said block.

29. A method for installing at least one of a pipe and a cable comprising:
disposing at least one of a plurality of support blocks at a predetermined location;
turning the one support block so that a side of the one support block, corresponding to the at least one of the pipe and the cable, is facing toward a first direction, the side having an opening and a cavity corresponding to the at least one of the pipe and the cable;
placing the at least one of the pipe and cable over the one support block from the first direction; and
snapping in the at least one of the pipe and cable into the cavity.
